(19) United States
(12) Patent Application Publication
(10) Pub. No.: US 2026/0278286 A1
(43) Pub. Date: Sep. 17, 2026

(54) TECHNIQUES FOR EVALUATING COMMUNICATIONS USING A LARGE LANGUAGE MODEL

(71) Applicant: GONG.io Ltd., Ramat Gan (IL)

(72) Inventors: Edith RONEN, Ramat Hasharon (IL); Danit Berger ZALMANSON, Herzliya (IL); Elad MENASHE, Tel Aviv (IL); Yulia PATKIN, Ganei Tikva (IL); Mor BENAYOUN, Rehovot (IL); Nelly Ariela FREID, Tsur Yigal (IL); Shani LEVI, Hod Hasharon (IL)

(73) Assignee: GONG.io Ltd., Ramat Gan (IL)

(21) Appl. No.: 19/080,005

(22) Filed: Mar. 14, 2025

(51) Int. Cl. G06F 40/40

(52) U.S. Cl. CPC G06F 40/40

(57) ABSTRACT

Techniques for generating structured evaluation on communication effectiveness are presented. The method includes ingesting input data that includes processed textual data and a user question policy, wherein the user question policy has a question parameter and at least one output structure; generating a prompt based on the ingested input data; applying a language model to the generated prompt to output an evaluation of textual data of the processed textual data, wherein the evaluation is a response to the question parameter that is formatted according to the at least one output structure, wherein the evaluation describes a communication effectiveness; and associating the evaluation with textual data of the processed textual data.

### TECHNICAL FIELD

The present disclosure relates generally to processing textual data, more specifically to techniques for analyzing communications and generating structured evaluations with improved accuracy.

### BACKGROUND

Customer service representatives, account executives, sales development representatives, customer success managers, and other business-to-customer (B2C) and business-to-business (B2B) representatives rely on engaging with customers or potential customers to achieve their business goals, such as meeting sales quotas, obtaining customer satisfaction, and so on. An important part of achieving such goals is the effective adoption of company approaches and guidelines in communications with the customers, individuals, and/or businesses.

Engagement with customers occurs via different communication channels, including phone calls, video calls, text messages, electronic mail (emails), and so on. In addition, the stage (or status) of a deal and the history of customer engagement with regard to that deal are typically recorded in a customer relationship management (CRM) system. These days, a sales process is very complex in that it requires the involvement of multiple sales professionals at various hierarchical levels, such as, for example, sales development representatives (SDRs), sales representatives, front-line managers (FLMs), and account executives. Each group of sales professionals may have different duties and responsibilities. To meet their respective goals, sales professionals are given some company guidelines, such as discovery questions, action steps, protocols, and the like, by which to abide.

Sales professionals at various hierarchical levels face challenges to implement such company guidelines and further to assess the conductance and/or effectiveness of such guidelines. Communications are often recorded for subsequent review. These tasks of reviewing are currently performed manually by sales professionals. However, in view of the exponential amount of information and communications (emails, calls, messages, CRM data, etc.) being processed, these tasks are time-consuming and prone to human error, which can result in critical details being overlooked and a subsequent decline in sales productivity.

Extraction of sales and communication information from records such as calls, meetings, emails, and the like have been performed by, for example, identification of keywords or phrases in conversations saved in the textual corpus. The identification of keywords may flag meaningful conversations to follow up on or provide further processing and analysis. For example, identifying the word “expensive” in sales conversations may be utilized to improve the sales process. However, current approaches are often isolated analyses of individual conversations and rely on keywords that may be misleading without consideration of context, for example, within the sentences, customer, company, field of business, and more. Furthermore, such manual analysis can be time-consuming and resource intensive given the continuous communications shared between sales professionals and customers.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for generating structured evaluation on communication effectiveness. The method comprises: ingesting input data that includes processed textual data and a user question policy, wherein the user question policy has a question parameter and at least one output structure; generating a prompt based on the ingested input data; applying a language model to the generated prompt to output an evaluation of textual data of the processed textual data, wherein the evaluation is a response to the question parameter that is formatted according to the at least one output structure, wherein the evaluation describes a communication effectiveness; and associating the evaluation with textual data of the processed textual data.

Certain embodiments disclosed herein also include a non-transitory computer readable medium having stored thereon causing a processing circuitry to execute a process, the process comprising: ingesting input data that includes processed textual data and a user question policy, wherein the user question policy has a question parameter and at least one output structure; generating a prompt based on the ingested input data; applying a language model to the generated prompt to output an evaluation of textual data of the processed textual data, wherein the evaluation is a response to the question parameter that is formatted according to the at least one output structure, wherein the evaluation describes a communication effectiveness; and associating the evaluation with textual data of the processed textual data.

Certain embodiments disclosed herein also include a system for generating structured evaluation on communication effectiveness. The system comprises: a processing circuitry; and a memory, the memory containing instructions that, when executed by the processing circuitry, configure the system to: ingest input data that includes processed textual data and a user question policy, wherein the user question policy has a question parameter and at least one output structure; generate a prompt based on the ingested input data; apply a language model to the generated prompt to output an evaluation of textual data of the processed textual data, wherein the evaluation is a response to the question parameter that is formatted according to the at least one output structure, wherein the evaluation describes a communication effectiveness; and associate the evaluation with textual data of the processed textual data.

Certain embodiments disclosed herein include the method, non-transitory computer readable medium, or system noted above or below, further including or being configured to perform the following step or steps: processing the textual data to generate processed textual data of semantic data chunks, wherein the processed textual data includes a portion of the textual data.

Certain embodiments disclosed herein include the method, non-transitory computer readable medium, or system noted above or below, further including or being configured to perform the following step or steps: aggregating evaluations of a plurality of textual data based on metadata; and determining an overall evaluation from the aggregated evaluations, wherein the overall evaluation describes a comprehensive communication effectiveness of the plurality of textual data.

Certain embodiments disclosed herein include the method, non-transitory computer readable medium, or system noted above or below, wherein the metadata is any one of: a representative identifier, a customer identifier, a time stamp, and communication statistics.

Certain embodiments disclosed herein include the method, non-transitory computer readable medium, or system noted above or below, further including or being configured to perform the following step or steps: generating a notification including the evaluation for display via a user device.

Certain embodiments disclosed herein include the method, non-transitory computer readable medium, or system noted above or below, further including or being configured to perform the following step or steps: tokenizing the textual data into the data chunks represented as vectors; and generating the processed textual data, wherein the processed textual data includes at least one of: a summary, a brief, highlights, simplified transcripts, and tracker data.

Certain embodiments disclosed herein include the method, non-transitory computer readable medium, or system noted above or below, wherein the textual data is a communication transcript of any one of: a call, email exchanges, a chat, and instant messages.

Certain embodiments disclosed herein include the method, non-transitory computer readable medium, or system noted above or below, wherein the user question policy includes background data of a company and a user.

Certain embodiments disclosed herein include the method, non-transitory computer readable medium, or system noted above or below, wherein the at least one output structure is selected from a predefined list of output structures, wherein the predefined list includes at least one of: Boolean, open question, description in sentences, a score, a multiple choice list, and a range.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a flow diagram illustrating an operation of evaluating communications according to an embodiment.

FIG. 3 is a flowchart illustrating a method for comprehensive evaluation of communications according to an embodiment.

FIG. 4 is a flowchart illustrating a method for determining an overall evaluation according to an embodiment.

FIG. 5 is a schematic diagram of a generator according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be plural and vice versa with no loss of generality. In the drawings, like numerals refer to like parts through several views.

The various disclosed embodiments present a system and a method for effectively evaluating communications by generating an enhanced prompt for employing in an artificial intelligence (AI) model, such as a large language model (LLM). The enhanced prompt is generated by applying at least one AI-based model to obtain a coherent and accurate prompt for analyzing the textual data of communications, for example, of a sales professional's conversation through various mediums. The communications include, for example, but not limited to, telephone calls, videoconference calls, electronic mail (email) correspondences, chats, instant messages, text messages, and the like, and any combination thereof. The embodiments disclosed herein apply the LLM model to automatically determine a response to a request (or question) related to the effectiveness of the communications. That is, the disclosed embodiments provide an accurate evaluation of the communications with respect to one or more questions that indicate communication effectiveness or alignment with the company guidelines.

The disclosed embodiments generate a well-structured, enhanced prompt that enables contextual knowledge of the conversation, the company, the field of business, and the questions being asked for comprehensive evaluation of the communications. It should be noted that the analysis is not limited to identification but an automated evaluation of the communications with respect to the background information. The enhanced prompt includes a first input text portion that is smaller in size through steps of pre-processing the original conversation. For example, the textual data of a call transcript may be reduced to 30% in size through the pre-processing process.

Current methods of reviewing sales related communications rely on manual reviewing and evaluations from personnel in the company, for example, a manager role in the sales department. Such manual review is not only time consuming, but also unrealistic considering the number of conversations being conducted and recorded, particularly, at a large call center with a large number of sales reps. Some automated approaches to identify certain features through, for example, keyword searches, can be employed. However, it should be noted that such techniques are limited identification of words without context or understanding of the conversations. To this end, such techniques are also prone to unintended and/or undesired errors.

Moreover, even if the evaluation of conversations can be performed, manual evaluations are often subjective based on the person performing the evaluation. As an example, the evaluation may differ between different people (e.g., managers) and may even differ from the same person performing the evaluation at different times, in different moods, and the like, because decisions can be made based on feelings. The embodiments disclosed herein eliminate such subjective decisions and provide an objective decision-making process based on the rules of generating the enhanced prompt and the rules of the employed LLM model.

According to the disclosed embodiments, the evaluation of the one or more communications may be output in various forms including, but not limited to, a Boolean, a natural language description, a multiple choice, a score, a range of scores, and the like, and any combination thereof. Such evaluation outputs are generated objectively through the LLM and may provide a quantitative analysis of the effectiveness and/or coherence to the company guidelines that are input as question parameters.

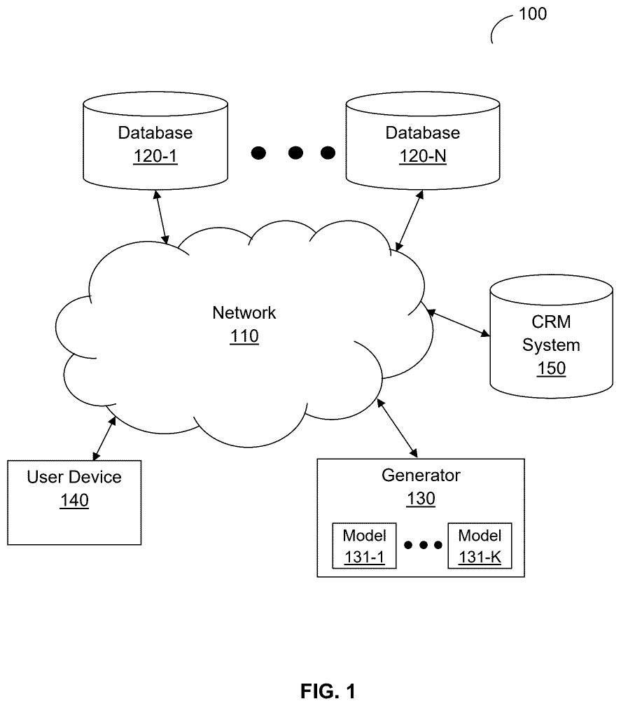

FIG. 1 shows an example network diagram 100 utilized to describe the various disclosed embodiments. In the example network diagram 100, a plurality of databases 120-1 through 120-N (hereinafter referred to individually as a database 120 and collectively as databases 120, merely for purposes of simplicity), a generator 130, a user device 140, and a CRM system 150 are communicating via a network 110. The network 110 may include but is not limited to, a wireless, cellular, or wired network, a local area network (LAN), a wide area network (WAN), a metro area network (MAN), the Internet, the world wide web (WWW), similar networks, and any combination thereof.

The database 120 is a data corpus (or simply “corpus”) that includes textual data that is related to communications such as, but not limited to, textual conversations, telephonic calls, video conference calls, and the like, and any combination thereof for a sales professional (e.g., sales representative of a company). The communications may be within the company, external to the company, between the representative of the company and a customer, and the like. The textual data includes transcripts from, for example, but not limited to, recorded calls or conversations, email messages, chat messages, instant messages, short message systems (SMS), chat logs, comments left on calls, and other types of textual documents. The textual data of various communications by the sales representative (hereinafter referred to as a rep for simplicity) are valuable in sales production, customer service, and assistance to the reps themselves. As noted above, a significant amount of such textual data may be generated and stored for reps within a company, customers communicating with the reps, a call center, a department of a company, and more. To this end, analysis and evaluation of these communications are challenging to perform, at least due to the large number, particularly with sufficient accuracy and reliability.

In an embodiment, the textual data in the database 120 include communication records, such as transcripts of telephone communications with customers. As an example, the textual data may include sales-related communication with a company and its customers. The textual data may originate from various types of communications such as, but not limited to, audio, video, image, virtually augmented sources, and the like; and thus, are not limited to communications using written texts. The textual data may be associated with metadata for identification of the textual data. The metadata includes associated information such as, but not limited to, participants'information (e.g., rep identifier (ID), customer ID, department, technology, product, etc.), a time stamp, a time frame, call statistics (e.g., how much each person spoke, when each person spoke, etc.), and the like, and more.

The database 120 may also include pre-processed textual data that are generated by applying at least one AI-based model 131 to the textual data of the communications. In an embodiment, the pre-processed textual data may include summarized textual data, tracker data, or both. The summarized textual data may be created by applying a language model such as, but not limited to, a large language model, a specifically trained language model (STLM), and the like, as described in further detail below. The summarized textual data is a shorter, more concise form of the textual data that excludes irrelevant or less meaningful information. As an example, the summarized textual data excludes small talk conversations that are less relevant to the company guidelines. The summarized textual data reduces the size of the textual data, for example, to one-third of the original textual data collected from the conversation.

In a further embodiment, the pre-processed textual data in the database 120 may include tracker data related to the textual data. The tracker is a keyword or phrase with a specific context and provides a general concept of a word or phrase. The tracker data indicates presence of one or more trackers that are predefined by the company. It should be noted that the tracker identifies the concept in consideration of the context in order to provide more accurate identification of the tracker concept than, for example, keyword matching. In some embodiments, the database 120 may include the textual data or pre-processed textual data as a plurality of segmented portions (or textual units), each associated with a tracker that the segmented portion describes. According to the disclosed embodiments, the pre-processed textual data may be generated continuously, intermittently, or at predefined time intervals on the new textual data. The pre-processed textual data may be stored in association with relevant metadata for identification and retrieval.

In some implementations, the database 120 also includes topic data related to topics identified through each call. A topic is the context of the subject matter in the text. Examples of topics include the subject matter of, for example, but not limited to, “small talk,” “pricing,” “next step,” “contract,” “sports,” and so on. A database 120 also includes sentiment data identifying a sentiment through each call. Sentiment may be positive, negative, or neutral. In an embodiment, textual data includes, for example, but is not limited to, transcript data, message data, and the like, and more.

The CRM database system 150 includes CRM data on the various customers that are utilized for keeping and monitoring sales processes and communications. Examples of such information may include textual data, information from a product board, net promotor score (NPS) ratings, a stage of a deal, an outcome of the deal, a date stamp, a company team, a vertical market, a business line, a tier, and more.

The generator 130 is a system, a server, a component, or the like, that is configured with a plurality of artificial intelligence (AI)-based models 131-1 through 131-K (hereinafter referred to individually as a model 131 and collectively as models 131, merely for purposes of simplicity, wherein the K is an integer greater than 1) to process textual data and comprehensively evaluate the textual data stored in the database 120. As noted above, the textual data are data representing the communications performed by a person (e.g., rep) in the company. The AI-based models 131 is, for example, but not limited to, a machine learning model, a classification model, a language model, a large language model (LLM), a specific-trained language model (STLM), a generative artificial intelligence model (GenAI), or the like, and more.

The generator 130 is configured to process the data in one or more of the databases 120, the CRM system 150, and the user device 140 using one or more models 131 in order to generate the feedback. The feedback includes evaluations of the communications with respect to, for example, a rep, a group of reps, a call center, a call, a customer, and the like, and any combination thereof. The evaluations are determined in response to questions of the prompt that are related to assessing the communications in view of, for example, effectiveness, company criteria or guidelines, and the like. Such questions may be defined by a user via a user device 140 and may be directly received from the user device 140, retrieved from the database 120, or the like, and may be selected from a user question policy. The user question policy may include a set of predefined questions and a plurality of rules for applying them.

Some examples of questions in concise forms may include, without limitations, “Does the representative walk through the recommended key functionalities in the live demonstration?”, “Does the representative start with an agenda?”, “Does the representative demonstrate pre-call research?”, “Did the representative pitch a multi-year deal?”, and the like. As an example, the feedback response generated from the generator 130 includes an answer to the question “Did the rep start with a recap?” for a telephone call between the rep and a customer that is represented as a Boolean (Yes or No) and a few sentences describing the relevant communications. The output feedback is caused to be displayed at the user device 140, for example, as a notification.

The generator 130 is configured to generate an enhanced prompt to be fed into the model 131, for example, a generally trained large language model (LLM), for generating the evaluation feedback. The generated prompt includes multiple portions, for example, but not limited to, an input text, a task, a parameter, at least one output structure, and the like, and are enriched by one or more models 131. The first input text portion of the prompt is the communications data to be evaluated, the second task portion is the background context (e.g., company information, company's field of operation, user's position or role, etc.). The third parameter portion includes at least one question for which the evaluation is to be performed and answered. The parameter may include multiple parameters to describe the desired evaluation. The fourth portion has at least one output structure that indicates the format or style of the feedback may include, but is not limited to, Boolean, open question, description in few sentences, score, multiple choice, range, and the like, and any combination thereof. In an example embodiment, the output structure is selected by a user. It should be noted that the enhanced prompt is generated to provide more accurate instructions and relevant input texts to the model.

In an embodiment, the first input text portion may include pre-processed textual data (or modified textual data) of the communication such as, but not limited to, a call, email exchanges, chat transcripts, and the like, and any combination thereof. That is, the input text is obtained through pre-processing of the textual data of the databases 120 and customer data of the CRM system 150. In an example embodiment, the input text is a communication summary that is a summarized, smaller textual data of the original textual data. In another example embodiment, the input text has tracker data that indicates the relevance of the textual data to one or more trackers (e.g., concepts). In some implementations, the input text may include or exclude certain textual data that is labeled with relevant or irrelevant trackers, respectively, to that of the question (i.e., the parameter). It should be noted that the input text is pre-processed to reduce the amount of textual data, thereby reducing the processing load and size and further increasing the accuracy of the prompt.

The third parameter portion of the generated prompt includes at least one question for which the user desired answers in relation to the communication quality, effectiveness, and company guidelines. In an embodiment, the parameter includes a rephrased question for a specific and accurate prompt to the model 131. The rephrased question may be generated from the one or more sentences that the user inputs in the natural language describing the context, examples, and the like criteria related to the question being asked. The rephrased question may be segments of textual data that accurately represent the question and are added as the parameter of the enhanced prompt.

The user device (UD) 140 may be, but is not limited to, a personal computer, a laptop, a tablet computer, a smartphone, a wearable computing device, or any other device capable of receiving and displaying the generated evaluation and comprehensive feedback on the communications. The user device 140 is utilized to enter one or more questions related to assessing the effectiveness of the communications. As noted above, the question may be entered as one or more sentences in the natural language describing the context, examples, and the like criteria related to the question being asked, which may then be rephrased at the generator 130. In some implementations, the user device 140 is also configured to select the output structure of the answer to the questions and the comprehensive feedback, the question parameter, and the like. In such a scenario, the questions and output structures may be predefined in a user policy for selection.

In an embodiment, the user device 140 is configured to display the evaluations and communications feedback in structured formats in forms of, for example, but not limited to, a notification, a list, a report, a suggestion, and the like. In some embodiments, the feedback may be presented to a user via an interactive graphical user interface (GUI). The GUI provides at least a portion of the evaluation to provide a response with respect to, for example, but not limited to, a question, a representative, a customer, and the like, and any combination thereof on the analyzed input text.

As an example, a user (e.g., a sales manager) may select a specific rep with a unique representative identifier (rep ID) and a first question of “Did the representative discuss the customer's goals?” in order to receive evaluations on the first question between the communications that the unique representative has with customers over one or more calls. In such a scenario, the user device 140 is configured to display the answer to the question with evaluation results determined using the disclosed method in a structured form as requested initially. In a further example embodiment, the user may interact with the notification to review the displayed answer and input an approval or a disapproval regarding the evaluation results.

It should be noted that the elements and their arrangement shown in FIG. 1 are shown merely for the sake of simplicity. Other arrangements and/or a number of elements should be considered without departing from the scope of the disclosed embodiments. For example, the generator 130 and the plurality of databases 120 may be part of one or more data centers, server frames, or cloud computing platforms. In another example, one or more of the plurality of models 131 may be communicatively connected to the generator 130 over the network 110.

The cloud computing platform may be a private cloud, a public cloud, a hybrid cloud, or any combination thereof. Examples of public cloud computing environments include Amazon® Web Services (AWS), Microsoft Azure, or Google® Cloud Platform (GCP), which offer shared infrastructure managed by the cloud provider, providing scalability, flexibility, and reduced infrastructure management.

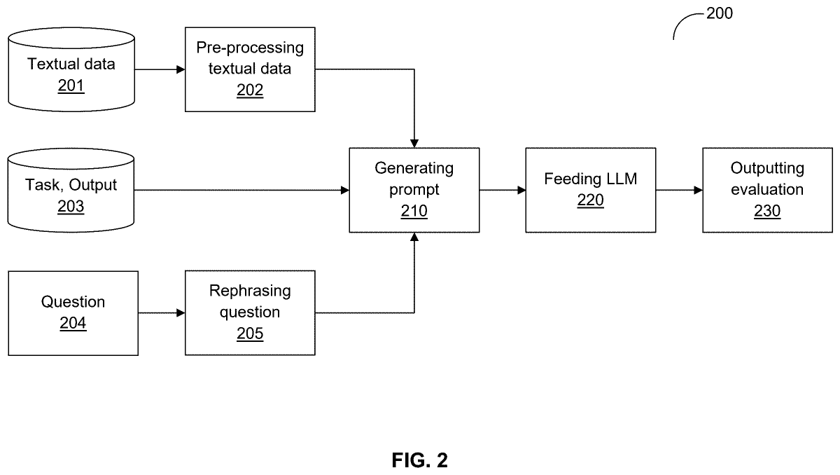

FIG. 2 is an example flow diagram 200 illustrating an operation of evaluating communications according to an embodiment. The flow diagram 200 herein may be performed within the generator 130 and employing at least one model 131, FIG. 1. For simplicity and without limitation of the disclosed embodiments, FIG. 2 will also be discussed with reference to the elements shown in FIG. 1.

Textual data 201 is retrieved from the database (e.g., the database 120, FIG. 1). The textual data includes communications data between the representative (rep) and one or more customers via, for example, a telephonic call, a videoconference call, email correspondence, chats, instant messaging, and the like, and any combination thereof. The textual data 201 may be transcripts of such communications. The textual data 201 are tokenized into smaller pieces of textual chunks and, further, transformed into their vector representations. In an embodiment, such textual data 201 may be associated with metadata such as, but not limited to, a rep identifier (rep ID), a customer identifier (customer ID), a time stamp, call (or communications) statistics, and the like, and any combination thereof. The textual data 201 may be stored as tokenized, vector representations in the database 120 and retrieved therefrom. It should be noted that the database 120 includes a large pool of communications being continuously generated between the reps of the company and the customer. To this end, manual review and analysis of each of the communications is impractical and requires an indefinite amount of time and resources.

The retrieved textual data 201 are pre-processed 202 to generate modified communications (textual data). In an embodiment, the modified textual data is a summary of a communication (e.g., a call) that is generated to reduce the size of the textual data. In another embodiment, the modified textual data includes tracker data that is generated to identify relevant tracker labels for the textual data. The tracker data labels portions or whole textual data with one or more tracker labels that are each associated with a tracker (e.g., a concept). In yet another embodiment, the pre-processed data includes summarized textual data and the tracker data for given textual data, for example, a transcript of a call. The pre-processing of textual data is performed by applying at least one the AI-based models 131, for example, a machine learning model, a classification model, a language model, a large language model (LLM), a specific-trained language model (STLM), a generative artificial intelligence model (GenAI), or the like, and more.

The summarized data may be generated in different formats, for example, but not limited to, concise description, bullet points, and the like, and any combination thereof. The summarized textual data may be generated for one or more communications such as, but not limited to, telephone calls, videoconference calls, email exchange threads, chat exchanges, and the like, and more. Such summarized communications may be stored in the database 120 with their metadata. In an example embodiment, the summarization is performed using a specific-trained language model (STLM) to output a comprehensive summary related to, for example, sales deals. It should be noted that the summarization of communications reduces the amount of textual data significantly for further processing. As an example, the textual data for a communication is reduced to one-third of the original textual data of a call. A non-limiting example of summarizing the textual data using a generative model is described in detail in U.S. patent application Ser. No. 18/638,062 to Ben-David et al., assigned to the common assignee, the contents of which are hereby incorporated by reference.

The tracker data that identifies the tracker, indicating concepts in portions and the whole of the communications, is determined through pre-processing 202. A non-limiting example of a tracker model to identify tracker (i.e., concepts) in the textual data is described in detail in U.S. patent application Ser. No. 17/649,453 to Horev et al., assigned to the common assignee, the contents of which are hereby incorporated by reference.

Such pre-processed textual data may be continuously, intermittently, or regularly performed as new textual data is recorded and received from ongoing communications of reps in the company, which are stored at the database 120. It should be noted that pre-processing of the textual data 201 reduces the textual data for the prompt and further processing to generate the evaluation. For example, the modified textual data that is summarized may be about one-third the size of that of the original textual data 201. It should be further noted that the modified textual data may include relevant portions or highlighted relevant portions with respect to the company, business field, rep, data center, customer, or the like, which provide visibility and insights on the textual data. Moreover, such relevant textual data provide direction to improve accuracy and computational efficiency of the evaluation.

At least one question 204 is received from, for example, the database 120, the user device 140, or the like. The question 204 describes the query for which an evaluation and response are being requested. Such question may be input in a natural language as text or a voice recording without specified structure including, for example, criteria, examples, and the like, related to the question.

To this end, the received question 204 is rephrased 205 using one or more AI-based models 131 such as LLMs for further processing. The rephrasing 205 involves transforming the question into a vector representation. In an embodiment, the rephrasing 205 includes deriving key portions or topics and generating a concise version of the question. In an example embodiment, the rephrasing eliminates irregularities from textual data that are often conversational. The rephrased questions 205 may be uniformly formatted data structures to facilitate retrieval and processing. The rephrased question 205 may be performed as new questions are received from the user device 140 or during initial setup of the policy. In some implementations, the rephrased questions 205 are stored as predetermined questions in the policy for the user (e.g., the user of the user device 140) to select from. In such a scenario, the rephrased question 205 is stored in the database 120 and retrieved for generating the prompt 210.

Moreover, a task including background and context of the company and the output structure 203 is received from the database 120. As noted above, the task describes the background setting of the question including, for example, but not limited to company information, the company's business field, company goals, and the like, and any combination thereof. The output structure defines how the evaluation response should be output from the AI-based model 131. Some examples of the output structure include, without limitation, Boolean, a few sentences of description, a score, a range of scores or percentages, a multiple choice, and the like, and any combination thereof. The tasks and the output structure 203 may be stored as part of a user question policy. In an embodiment, the task and output 203 may be changed at the user device 140 and provided output 203.

According to the disclosed embodiments, at least the pre-processed textual data 202, the task and output structure 203, the rephrased question 205, are aggregated to generate an enhanced prompt 210 to feed into the one of the AI-based models, for example, and without limitation, an LLM. The enhanced prompt 210 is a single coherent prompt including, for example, but not limited to, the input text, the task, at least one parameter, the output structure, and the like, and any combination thereof. The enhanced prompt 210 is a well-structured prompt including details on the background, targeted parameters, and output. Moreover, the pre-processed textual data 202 are employed as input data to provide reduced textual data with relevance. The language model (LM) or LLM is, for example, but not limited to, Generative Pre-trained Transformer-3 (GPT-3), Generative Pre-trained Transformer-J (GPT-J), Generative Pre-trained Transformer-4 (GPT-4), Text-to-Text Transfer Transformer (T5), Bidirectional and Auto-Regressive Transformers (BART), Language Model for Dialogue Applications (LaMDA), Large Language Model Meta AI (LLaMA), and the like, and more.

Such generated prompt 210 is fed to the LLM 220 to output the evaluation 230 as a response to the question 204. The LLM 220 may be a general LLM that is trained for general usage. The evaluation 230 is output according to the output structure 203 added to the prompt 210. In some embodiments, the output from the LLM 220 may be parsed to generate the evaluation 230. The output evaluation 230 is associated with the original textual data 201 and/or its metadata and stored in the database 120. In an embodiment, the output evaluation 230 may be generated as part of a notification as provided for display at the user device 140. In another embodiment, a plurality of the output evaluations 230 from a plurality of communications may be aggregated according to, for example, but not limited to, a rep, a group of reps (e.g., department in company), customers, and the like, and any combination thereof for comprehensive evaluation on the communications.

It should be noted that the flow diagram 200 shows an operation for a single question for illustrative purposes. The operation to evaluate communications and respond to questions may be simultaneously performed for a plurality of questions, communications, reps, and the like.

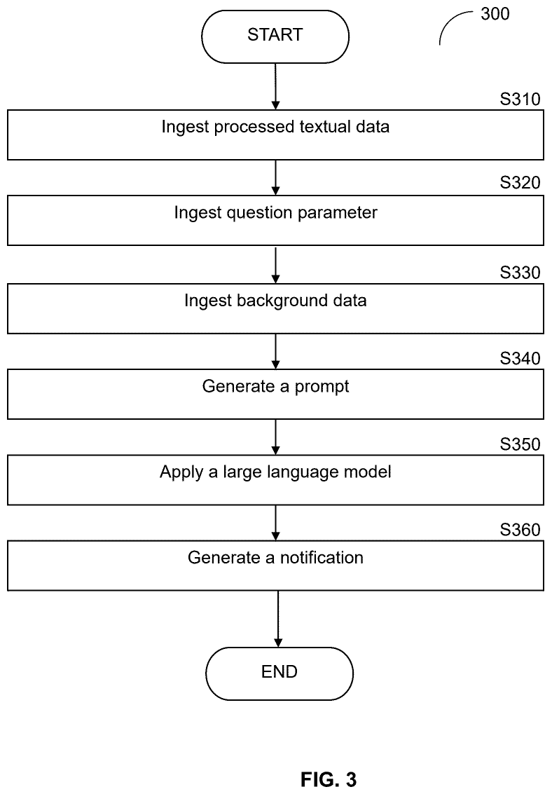

FIG. 3 is an example flowchart 300 illustrating a method for comprehensive evaluation of communications according to an embodiment. The method of FIG. 3 is performed in the generator 130 employing one or more AI-based models 131 such as an LLM.

At S310, at least one question is ingested. The at least one question is ingested from, for example, but not limited to the database 120, the user device 140, and the like, and any combination thereof. The at least one question is related to the communications between the reap and a customer in order to determine, for example, quality, effectiveness, alignment to company goals and/or guidelines, and the like of such communications. In an embodiment, the at least one question may be a rephrased question that is reformatted and reparsed, for example, by applying a specific-trained language model (STLM).

At S320, pre-processed textual data is ingested. The pre-processed textual data are generated by applying at least one AI-based model such as, but not limited to, an LLM, an STLM, a classifier, and the like. The textual data are communications data collected and stored from various communications that a rep exchanges with one or more customers and may include transcripts of, for example, but not limited to, a call, emails, instant messages, text messages, and the like, and any combination thereof. The textual data are tokenized and transformed into vector representations and pre-processed. In an embodiment, the pre-processed textual data is generated continuously, intermittently, regularly, or on-demand, as new textual data is collected and stored at the database (e.g., the database 120, FIG. 1).

In an embodiment, the pre-processed textual data is a summarization of the collected textual data and includes, for example, but is not limited to, call highlights, call briefs, deal briefs, deal summaries, simplified call transcripts, and the like, and any combination thereof. In another embodiment, the pre-processed textual data includes tracker data that labels portions and/or the whole textual data with a relevant tracker label. The tracker label indicates that the labeled textual data includes discussions related to the tracker (or a concept) associated with keywords or phrases. An example of the tracker may be “pricing objective” which encompasses keywords, such as “expensive,” “high-priced,” “overpriced,” and “overrated” or phrases, such as “it is too expensive,” “I can't afford that,” and so on. In yet another embodiment, the pre-processed textual data is a combination of the summarization and tracker labels. It should be noted that the pre-processed textual data provides additional information and context to the originally stored textual data that is more closely relevant to the company and/or question. It should be further noted that the pre-processed textual data is smaller in size with less textual segments. In some embodiments, the pre-processed textual data may be generated based on the injected question (S310).

At S330, background data is ingested. The background data includes the context and setting in which the question and evaluation are performed and may be retrieved from the database 120, the user device 140, and the like, and any combination thereof. The background data provides information on, for example, the company, the field of business, the role of the user, and the like, and any combination thereof. As an example, the background data describes that a manager (i.e., the user) of a customer service call center in a fashion retail business is querying about a rep at the call center. Here, the background data may include company-specific information such as, without limitation, terminology.

At S340, an enhanced prompt is generated. The ingested data of the at least one question, the pre-processed textual data, background data, metadata associated with the pre-processed textual data, and the like, are aggregated to generate the enhanced prompt. In an embodiment, the enhanced prompt includes the pre-processed textual data as an input text, the background information as a task, the at least one question as at least a parameter, and an output structure. The output structure is a format such as, but not limited to, a Boolean, a natural language description, a score, a range of scores, a multiple-choice selection, and the like, and any combination thereof, for which the response of the question is to be output. The enhanced prompt is a coherent and well-structured prompt that may be specified for the company and/or the question. Moreover, the enhanced prompt is generated based on processed textual data and question, to reduce the prompt size in comparison to a prompt including all parts of the original textual data as collected and stored.

At S350, a large language model (LLM) is applied to the generated prompt. The enhanced prompt is fed to the LLM to analyze the input text with respect to the background data and the at least one parameter (i.e., the at least one question) in order to generate a response to the at least one parameter question. In an embodiment, applying the LLM includes feeding the LLM with the enhanced compact prompt. In a further embodiment, applying also includes transmitting the smaller enhanced prompt to be fed into the LLM. As noted above, the enhanced prompt includes a first portion of the pre-processed input text, a second portion of at least one parameter question, a third portion of the task, and a fourth portion of the output structure. The generated output from applying the LLM is stored at the database (e.g., the database 120, FIG. 1). Some examples of LLM include, for example, but are not limited to, Generative Pre-trained Transformer-3 (GPT-3), Generative Pre-trained Transformer-J (GPT-J), Generative Pre-trained Transformer-4 (GPT-4), Text-to-Text Transfer Transformer (T5), Bidirectional and Auto-Regressive Transformers (BART), Language Model for Dialogue Applications (LaMDA), Large Language Model Meta AI (LLaMA), and the like, and more.

According to the question related to the quality or effectiveness of the communications, the response indicates an evaluation of the rep and customer communications. As an example, the response output indicates, in the structure requested in the prompt, whether the rep has performed the communication actions of the question. In another example, the output is a high numerical score, for example, 4 out of 5, indicating that the rep displayed pre-call research knowledge in the communication, in response to the parameter question of “did the rep demonstrate pre-call researching?”.

It should be noted that the output generated from applying the LLM provides an objective determination and evaluation of the question parameter based on the compact enhanced prompt and the LLM. In some implementations, a quantitative output of a score, range of scores or percentages, or the like, is provided that provides a concrete quantitative evaluation of the communication effectiveness. It should be further noted that the method described herein reduces the computational and transmittance load by utilizing the enhanced prompt, which is particularly impactful considering the continued communications between multiple reps with customers that are collected and stored for analysis.

At S360, a notification is caused to be generated. The notification may be caused to be displayed at a user device (e.g., the user device 140, FIG. 1). In an embodiment, the notification includes at least a portion of the output evaluation in response to the question. The notification may be automatically generated and displayed at other user devices (not shown) that are associated with a rep participating in the processed communication of the textual data ingested in S320. In an embodiment, the user may interact with the displayed notification to approve or disapprove the output evaluation. In such a scenario, the approved output evaluation may be displayed at the other user device of the rep. It should be noted that no manual or human intervention is necessary to generate evaluation output and the notification, thereby eliminating manual labor that is time and resource intensive.

In an embodiment, the notification may be displayed through a dashboard or graphical user interface (GUI) for the user to interact with. In an embodiment, the user may choose to see portions of the notification and select the viability of the evaluation.

In some implementations, the notification includes other insights that are determined and suggested to the user of the user device to perform. Such actionable insights are generated based on the aggregation of data from one or more communications to provide coaching tips that can be helpful for future communications. In an example embodiment, the insights are created by filling out a predefined template. For example, the predefined template includes a section listing “what went well” and a section listing “what you could have done better” to be generated based on output evaluations to multiple questions and at least one communication. In an example embodiment, the list for “what you could have done better” includes a description of lower scored question parameters and relevant textual segments.

The method of FIG. 3 is described with respect to a single rep for simplicity and does not limit the scope of the disclosed embodiments. The method may be performed for multiple reps, for example, to evaluate the communications from a group of reps, for example, working with the same customer, in the same department, managed by the same manager (e.g., the user), or the like, by modifying the first input text portion of the prompt. In addition, the method may be performed to evaluate the rep over a plurality of calls by aggregating textual data of the plurality of calls conducted by the rep. In an example embodiment, such evaluation is performed by adding the aggregated plurality of textual data as the first portion of the prompt. In another example embodiment, such evaluation is performed by aggregating evaluations from the plurality of textual data and applying at least one algorithm. It should be appreciated that, given the aggregation of calls, the pre-processing of the textual data to reduce and/or enrich the textual data is advantageous to reduce computational power and time as well as improved accuracy.

In some implementations, a real-time analysis of an ongoing call may be performed as the call transcript is ingested and added as input text of the prompt. Here, portions of the transcript textual data may be added, for example, intermittently, at predefined time intervals, on-demand, or both. The input text from the call transcript may be pre-processed as discussed above.

It should be noted that the disclosed embodiments are described with respect to questions related to the effectiveness, quality, and/or alignment of the communications with the rep and the customer in a company for illustrative purposes and do not limit the scope of the disclosed embodiments. The method of generating an enhanced prompt through processing of textual data and questions may be utilized to accurately and efficiently obtain answers to other parameter questions.

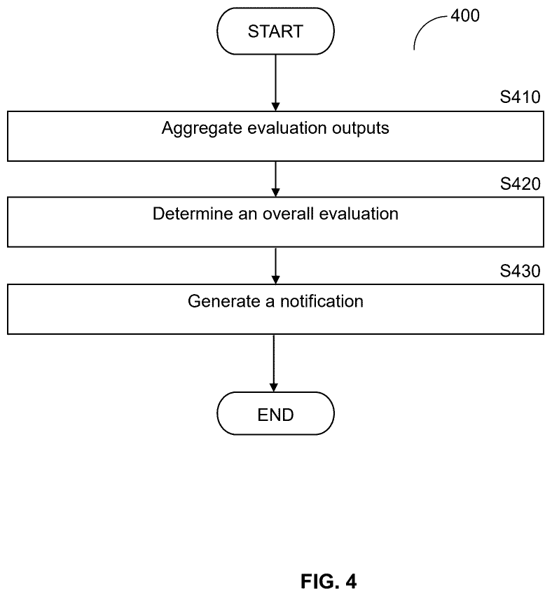

FIG. 4 is an example flowchart 400 illustrating a method for determining an overall evaluation according to an embodiment. The method described herein is performed at the generator 130, FIG. 1. The overall evaluation is a combined evaluation output that encompasses communication effectiveness with respect to multiple aspects. That is, the evaluation responses to multiple questions are processed to output a single representative evaluation output. In an example embodiment, the overall evaluation is determined for a single representative (rep) communicating with a customer. In another example embodiment, the overall evaluation is determined for a group of reps, for example, in the same department, managed by a single manager, for a single customer, or the like, and more.

At S410, evaluation outputs from a plurality of parameter questions are aggregated. The evaluation outputs may be aggregated with respect to, for example, but not limited to, a rep, a group of reps, a customer, or the like, employing the metadata associated with the textual data and the evaluation outputs. The evaluation outputs are generated according to the method of FIG. 3.

At S420, an overall evaluation is determined based on a plurality of combination rules. The plurality of combination rules has, for example, but is not limited to, weights, ranks, and the like, that are predetermined for a company and may be changed at different times. As an example, the plurality of combination rules has greater weight for a question “did the rep discuss a multi-year plan” over “did the rep start the conversation with greetings.” In an embodiment, at least one AI-based algorithm, such as a rule-based algorithm, may be applied to determine the overall evaluation.

At S430, a notification is generated to include the determined overall evaluation. The notification may include, for example, but not limited to, the determined overall evaluation, the textual data or rep that were analyzed for the overall evaluation, and the like, and any combination thereof. In an example embodiment, the notification may include a quantitative score and a natural language description of the evaluation. The notification may be caused to be displayed at one or more user devices of the user (e.g., manager, user asking a question, etc.) and the reps associated with the overall evaluation.

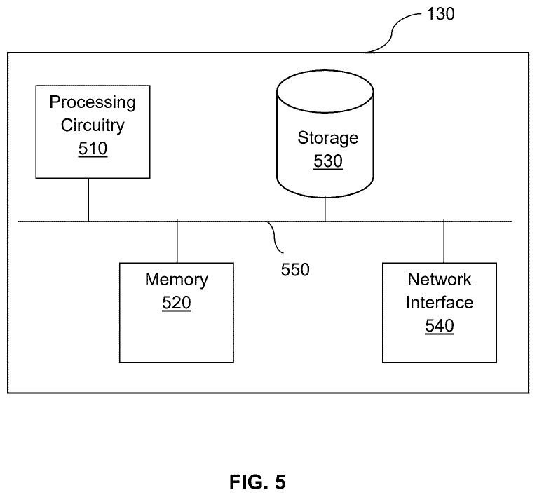

FIG. 5 is an example schematic diagram of a generator 130 according to an embodiment. The generator 130 includes a processing circuitry 510 coupled to a memory 520, a storage 530, and a network interface 540. In an embodiment, the components of the generator 130 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose central processing units (CPUs), microprocessors, microcontrollers, digital signal processors (DSPs), and the like, or any other hardware logic components that can perform calculations or other manipulations of information.

The memory 520 may be volatile (e.g., random access memory, etc.), non-volatile (e.g., read only memory, flash memory, etc.), or a combination thereof.

In one configuration, software for implementing one or more embodiments disclosed herein may be stored in the storage 530. In another configuration, the memory 520 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein.

The storage 530 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 540 allows the generator 130 to communicate with other elements over the network 110 for the purpose of, for example, receiving data, sending data, and the like.

It should be understood that the embodiments described herein are not limited to the specific architecture illustrated in FIG. 5, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), general purpose compute acceleration device such as graphics processing units (“GPU”), a memory, and input/output interfaces. The computer platform may also include an operating system and microinstruction code. The various processes and functions described herein may be either part of the microinstruction code or part of the application program, or any combination thereof, which may be executed by a CPU or a GPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for generating structured evaluation on communication effectiveness, comprising:
ingesting input data that includes processed textual data and a user question policy, wherein the user question policy has a question parameter and at least one output structure;
generating a prompt based on the ingested input data;
applying a language model to the generated prompt to output an evaluation of textual data of the processed textual data, wherein the evaluation is a response to the question parameter that is formatted according to the at least one output structure, wherein the evaluation describes a communication effectiveness; and
associating the evaluation with textual data of the processed textual data.

2. The method of claim 1, further comprising:
processing the textual data to generate processed textual data of semantic data chunks, wherein the processed textual data includes a portion of the textual data.

3. The method of claim 1, further comprising:
aggregating evaluations of a plurality of textual data based on metadata; and
determining an overall evaluation from the aggregated evaluations, wherein the overall evaluation describes a comprehensive communication effectiveness of the plurality of textual data.

4. The method of claim 3, wherein the metadata is any one of: a representative identifier, a customer identifier, a time stamp, and communication statistics.

5. The method of claim 1, further comprising:
generating a notification including the evaluation for display via a user device.

6. The method of claim 2, wherein processing the textual data further comprises:
tokenizing the textual data into the data chunks represented as vectors; and
generating the processed textual data, wherein the processed textual data includes at least one of: a summary, a brief, highlights, simplified transcripts, and tracker data.

7. The method of claim 1, wherein the textual data is a communication transcript of any one of: a call, email exchanges, a chat, and instant messages.

8. The method of claim 1, wherein the user question policy includes background data of a company and a user.

9. The method of claim 1, wherein the at least one output structure is selected from a predefined list of output structures, wherein the predefined list includes at least one of: Boolean, open question, description in sentences, a score, a multiple choice list, and a range.

10. A non-transitory computer readable medium having stored thereon instructions for causing a processing circuitry to execute a process, the process comprising:
ingesting input data that includes processed textual data and a user question policy, wherein the user question policy has a question parameter and at least one output structure;
generating a prompt based on the ingested input data;
applying a language model to the generated prompt to output an evaluation of textual data of the processed textual data, wherein the evaluation is a response to the question parameter that is formatted according to the at least one output structure, wherein the evaluation describes a communication effectiveness; and
associating the evaluation with textual data of the processed textual data.

11. A system for generating structured evaluation on communication effectiveness, comprising:
a processing circuitry; and
a memory, the memory containing instructions that, when executed by the processing circuitry, configure the system to:
ingest input data that includes processed textual data and a user question policy, wherein the user question policy has a question parameter and at least one output structure;
generate a prompt based on the ingested input data;
apply a language model to the generated prompt to output an evaluation of textual data of the processed textual data, wherein the evaluation is a response to the question parameter that is formatted according to the at least one output structure, wherein the evaluation describes a communication effectiveness; and
associate the evaluation with textual data of the processed textual data.

12. The system of claim 11, wherein the system is configured to:
process the textual data to generate processed textual data of semantic data chunks, wherein the processed textual data includes a portion of the textual data.

13. The system of claim 11, wherein the system is configured to:
aggregate evaluations of a plurality of textual data based on metadata; and
determine an overall evaluation from the aggregated evaluations, wherein the overall evaluation describes a comprehensive communication effectiveness of the plurality of textual data.

14. The system of claim 13, wherein the metadata is any one of: a representative identifier, a customer identifier, a time stamp, and communication statistics.

15. The system of claim 11, wherein the system is configured to:
generate a notification including the evaluation for display via a user device.

16. The system of claim 12, wherein the system is further configured to:
tokenize the textual data into the data chunks represented as vectors; and
generate the processed textual data, wherein the processed textual data includes at least one of: a summary, a brief, highlights, simplified transcripts, and tracker data.

17. The system of claim 11, wherein the textual data is a communication transcript of any one of: a call, email exchanges, a chat, and instant messages.

18. The system of claim 11, wherein the user question policy includes background data of a company and a user.

19. The system of claim 11, wherein the at least one output structure is selected from a predefined list of output structures, wherein the predefined list includes at least one of:
Boolean, open question, description in sentences, a score, a multiple choice list, and a range.
